(19) United States
(12) Patent Application Publication
(10) Pub. No.: US 2005/0256001 A1
(43) Pub. Date: Nov. 17, 2005

(54) Method for treating crops to enhance plant performance

(75) Inventors: Robert Smith, Salinas, CA (US); Anthony Jabar JR., Waterville, ME (US)

Correspondence Address: DAVID S. RESNICK, 100 SUMMER STREET, NIXON PEABODY LLP, BOSTON, MA, 02110-2131, US

(73) Assignee: Global Protein Products, Inc., Winslow, ME (US)

(21) Appl. No.: 10/530,625

(22) PCT Filed: Oct. 14, 2003
(86) PCT No.: PCT/US03/32428

§ 371 Date: May 19, 2005

(51) Int. Cl. A01N 25/26; A01N 43/16

(52) U.S. Cl. 504/116.1; 504/292

(57) ABSTRACT

The present invention relates to methods and compositions used to promote seed germnination, emergence, healthy root development, plant growth, disease resistance, maturity and ultimately increase tuber crop yield in agricultural commodities. The present invention also relates to seeds and seed pieces treated with the compositions and methods of the present invention. The compositions of the invention contain a polysaccharide and/or protein.

### CROSS REFERENCE

This international application claims the benefit of U.S. Provisional Application No. 60/417,860 filed 11 Oct. 2002.

### FIELD OF THE INVENTION

The present invention relates to methods and compositions used to promote seed germination, emergence, healthy root development, plant growth, disease resistance, maturity and ultimately increase tuber crop yield in agricultural commodities. The present invention also relates to seeds and seed pieces treated with the compositions and methods of the present invention.

### BACKGROUND OF THE INVENTION

Economic demands, environmental concerns, and ecological considerations require that farmers continually improve their agricultural practices. Seed today is more expensive, land more valuable, and regulatory compliance more stringent than any other time in history. These economic demands require that farmers utilize the most cost efficient practices in order to generate the highest crop yields.

Complicating this economic balance is the increasing consumer demand to utilize fewer chemicals and with lower toxicity. Additionally, environmental considerations such as contaminated runoff, spray drift, and worker safety continue to add pressure to the agricultural practices balance. Finally, ecological considerations have led to integrated pest management systems which further challenge the farmer's ability to produce crop yields and quality within the economic constraints prevalent in today's market.

Plant, soil and seed treatments are used on almost every commercial crop on the market today. In this era of intensified agriculture, the seed is often modified and exclusively owned and thus it is more important than ever to decrease the risk of plant and seed disease once expensive seed has been purchased. It is well known that protecting seed during the early part of the planting season is vital to obtaining high crop yields. Plant protection during the growing season is also of vital importance in obtaining high quality, high yielding crops.

The plants and seeds are subjected to a wide variety of conditions, which can negatively impact germination, emergence, root mass development, nutrient uptake, plant growth, and ultimately crop yield. Pathogenic fungi present a major challenge for growers. Seed storage and seed planting provide fungi with a favorable climate in which to propagate, leading to seed damage, plant damage, and crop yield losses. Unfortunately there are many genera of pathogenic fungi with which the grower must deal. Owing to the variety of fungi, there is no universal antifungal compound, which is effective on all types. Additionally, resistant type fungi development contributes to lower overall effectiveness of antifungal compounds, synthetic or otherwise. Ascochyta, Botrytis, Erypsiphe, Fusarium, Gaeumanomyces, Pythium, Rhizoctonia, Sclerotinia, and Verticillium are just a few of the many genera of fungi with which growers must contend.

In addition to disease control a seed treatment must also provide for optimum germination, emergence, and root development. Absorption of macro and micronutrients is essential for high crop yield development. All of this must be accomplished even under adverse growing conditions. Such a seed treatment is highly desirable.

### DESCRIPTION OF THE INVENTION

It is therefore an object of this invention to provide a seed or seed piece (e.g. potato or sugar beet) treatment composition which enhances rapid germination, uniform and early emergence, healthy root mass, higher rates of photosynthesis, plant protection, early maturity and ultimately increase crop yield.

It is also an object of this invention to provide a seed or seed piece (e.g. potato) treatment composition which is nontoxic and biodegradable, which will have minimal impact on worker safety, the environment, and the ecological considerations of the farm.

It is also an object of this invention to provide a composition, which is easily manufactured and easily applied using conventional and commercially available application equipment.

It is also an object of this invention to provide a coated seed or seed piece (e.g. potato) which exhibits increased germination, uniform and early emergence, healthy root mass development, disease resistance, and increased crop yield.

In one embodiment, the present invention provides a method of increasing tuber crop yield. In another embodiment, the present invention provides a method for accelerating tuber crop emergence and maturity. In a further embodiment, the invention provides a seed (e.g. potato) composition comprising a crop seed and a coating composition.

In one embodiment of the invention, the seed/tuber is contacted with a composition (coating composition) comprising an effective amount of a composition composed of 1-50% A and 50-99% B as a dry powder mix. Part A is comprised of a peptide (or protein) alone or a polysaccharide alone or a combination of the peptide and polysaccharide in a ratio ranging from 99.9% peptide: 0.1% polysaccharide to 0.1% protein: 99.9% polysaccharide that is blended. Part B is comprised of additives that promote stability and functionality of the final product.

In a preferred embodiment, the polysaccharide is used without the protein and the methods and seed composition of the present invention.

The polysaccharides used in the present invention are, in particular, hydrocolloid polysaccharides derived from plant, animal or microbial sources. Polysaccharides useful in the present invention include, but are not limited to, cellulosic derivatives such as carboxymethylcellulose, methylcellulose, hydroxypropyl cellulose, hydroxypropyl methylcellulose, microcrystalline cellulose, etc., starches and derivatives including, but not limited to, corn starch, tapioca starch, potato starch, rice starch, wheat starch, and modified versions thereof such as pregelatinized starch, oxidized starch, ethylated starch, starch dextrins, maltodextrin, etc. Additional polysaccharides useful in the present invention include, but are not limited to, pectin, polysaccharides derived from seaweed such as agar, alginates, carrageenan, and fucellaran, exudate gum polysaccharides such as gum arabic, gum ghatti, gum karaya, and gum tragacanth, seed gums such as guar gum and locust bean gum, polysaccharides derived from microbial fermentation such as xanthan gum and gellan gum, and nitrogen containing polysaccharides such as chitosan. Polysaccharides of the type described herein produced by tiansgenic organisms can also be useful in the present invention. Preferred polysaccharides for use in the invention are guar gum, starch dextrins, pectin, gum arabic, celluloses, carrageenan, alginates and mixtures thereof.

The peptide for use in the present invention can be isolated from a natural or recombinant source. Preferably, the natural source is of plant origin including maize, wheat, whey, and soybean. Preferred plant peptide sources are: corn gluten meal, zein, soybean protein, whey protein, wheat gluten, casein, gelatin, wheat flour, cottonseed meal, corn flour, oatmeal, pecan shell flour, pectin, rye flour, edible seaweed, soybean meal, soy flour, soy protein, sugarbeet meal, walnut flour, and ground oats. Alternatively, the peptide can be isolated from animal sources including bone meal, animal collagen, edible fish meal, meat meal, and nutria meal. Bakers yeast extract is also a preferred peptide source.

Part B comprises additives that promote the stability and functionality of the final product. Preferred additives include but are not limited to solubilizing agents such as glycol, propylene glycol, or other low molecular weight alcohols; surfactancts such as alkylpolyglucosides, fatty alcohols, fatty acids, or alkylbenzenesulfonates and dispersants; emulsifiers such as lecithin or sorbitan monooleate; pH control agents such as mineral acids and their salts, organic acids and their salts, bases, both organic and inorganic; buffers such as phosphates, acetates and carbonates; anti-microbial compounds such as BHT, methyl or propylparaben, benzoic acid, sorbic acid, propionic acid and their salts; chelataing agents such as EDTA, MEA or TEA; thickeners such as glucerol; drying agents such as fir bark and other such additives generally known or apparent to those skilled in the art.

The composition can be prepared by blending Part A with Part B. This blending can be carried put in conventional dry blending equipment.

The compositions made according to the methods above are then applied to seeds and seed (e.g. potato) pieces by conventional application equipment. Hopper blending, auger mixing, barrel dusting, disking, and spray dusting are all commercially available methods and are capable of treating seed pieces with the composition. Additionally, the compositions may be added directly to the soil by broadcast methods, disking, or row application.

Alternatively, the composition can be re-dispersed in water or other appropriate solvent, with or without the aid of conventional dispersants, emulsifiers or solubilizing agents, and applied to the seed piece as a solution. A bath type application can be utilized in the present invention followed by drying. Spray equipment may also be used to apply the solution, again followed by drying. Drying can be accomplished by forced air circulation, heated air circulation, atmospheric air drying, oven drying, or any other means which will have the effect of removing excess moisture from the seed piece.

The composition can be effectively used to treat seeds or seed pieces by direct application to the seeds or seed pieces before planting.

The compositions can be admixed with inert agents, bulking agents, or diluent materials in order to uniformly distribute the composition onto the seed piece surface. Materials which can be used in the present invention include, but are not limited to clay, talc, limestone, quick lime, silica, hydrated silica, bentonite, salts of organic acids, organic acids, surfactants, dispersants, emulsifiers, solvents, ash, composted materials, tree bark, and mixtures thereof. When admixing these materials care should be taken to insure that the appropriate amount of dry powder mix is distributed uniformly onto the seed piece.

Similarly, other functional ingredients may be added to the complex to simplify distribution of these ingredients onto the seed piece. When admixing these materials care should be taken to insure that the appropriate amount of the composition is distributed uniformly onto the seed piece.

When the composition is dissolved in aqueous or organic solution, additives may be added to the solution to promote stability of the components. Additives include, but are not limited to, solubilizing agents such as glycol, propylene glycol, or other low molecular weight alcohols; surfactants such as alkylpolyglucosides, fatty alcohols, fatty acids, or alkylbenzenesulfonates and dispersants; emulsifiers such as lecithin or sorbitan monooleate; pH control agents such as mineral acids and their salts, organic acids and their salts, bases, both organic and inorganic; buffers such as phosphates, acetates and carbonates; anti-microbial compounds such as BHT, methyl or propylparaben, benzoic acid, sorbic acid, propionic acid and their salts; chelating agents such as EDTA, MEA or TEA; and other such additives generally known or apparent to those skilled in the art.

The composition can be effectively used to treat soils, plant seeds or seed pieces either by direct application to the seed or seed piece before planting or, alternatively, the composition may be added during the planting process along with the seeds or seed pieces.

An effective amount of the composition is between 0.5-20 lbs./acre. For potatoes, for example, a preferred range is 10-18 lbs./acre.

The present compositions can also be added pre or post planting as either a foliar application, as a side dressing, or as a soil amendment admixed with the soil using conventional agricultural practices such as broadcasting, disking or row application.

The present invention can be used to enhance the germination, emergence, root mass development, disease resistance, photosynthetic rate, plant growth, and crop yield of a variety of agricultural commodities including but not limited to: vegetables, such as asparagus, beans, beets, broccoli, brussels sprouts, cabbage, carrots, cauliflower, celery, chayote, corn, cucumbers, eggplant, kohlrabi, okra, onions, garlic, parsnips, peas, peppers, potatoes, pumpkins, radishes, rutabagas, squash, turnips, lettuce, kale, collards, spinach, sweet potato, sugar beets, etc.; fruits, such as apples, apricots, avocados, bananas, cherries, coconuts, dates, grapes, guava, lychee, mangoes, melons, nectarines, papaya, peaches, pears, persimmons, pineapples, plantains, plums, pomegranates, prunes, stone fruit, strawberries, tomatoes, blueberries, raspberries, blackberries, and citrus fruits, such as grapefruit, oranges, lemons, limes, clementines and tangerines.

The present invention can be used to enhance the germination, emergence, root mass development, disease resistance, photosynthetic rate, plant growth, and yield of tuber crops.

### EXAMPLE

| Formulation | Average weight (cwt/acre) | Standard Deviation |
|---|---|---|
| PM223 | 244.5 | 9.0 |
| PM-G | 298.5 | 12.4 |
| PM-CMG | 261 | 43.9 |
| PM-CM | 247.5 | 20.4 |
| PM-PG | 192 | 6.9 |
| PM-P | 150 | 38.9 |

The following formulations were used to treat potato seed pieces:
PM-P: 0.25% zein; 30% limestone; 69.75% fir bark
PM-G: 2.75% guar gum; 30% limestone; 67.25% fir bark
PM-PG: 0.25% zein; 2.75% guar gum; 30% limestone; 67% fir bark
PM-CM: 0.25% corn gluten meal; 30% limestone; 69.75% fir bark
PM-CMG: 0.25% corn gluten meal; 2.75% guar gum; 30% limestone; 67% fir bark

It is also to be understood that the following claims are intended to cover all of the generic and specific features of the invention herein described and all statements of the scope of the invention which, as a matter of language, might be said to fall there between. Particularly, it is to be understood that in said claims, ingredients or compounds recited in the singular are intended to include compatible mixtures of such ingredients wherever sense permits.

1. A method of increasing crop yield, accelerating crop emergence, or accelerating crop maturity, comprising administering a composition comprising a polysaccharide on a seed or seed piece of said crop or to a soil in which said crop is cultivated.

2. (canceled)

3. (canceled)

4. The method of claim 1, wherein the polysaccharide is selected from the group consisting of a cellulosic derivative, starch or a starch derivative, pectin, carrageenan, an exudate gum polysaccharide, polysaccharide derived from seed gum and alginates.

5. The method of claim 4, wherein the cellulosic derivative is alpha cellulose.

6. The method of claim 4, wherein the starch or starch derivatives is tapioca starch or corn starch.

7. The method of claim 4, wherein the exudates gum polysaccharide is gum arabic, gum ghatti, gum karaya, and gum tragacanth.

8. The method of claim 4, wherein the polysaccharide may be derived from seed gum is guar gum or locust bean gum.

9. The method of claim 1, wherein said composition further comprises limestone.

10. The method of claim 1, wherein said composition further comprises a drying agent.

11. The method of claim 10, wherein the drying agent is fir bark.

12. The method of claim 1, wherein said polysaccharide is present in an amount of 0.1-99.9% by weight of the dry weight of the total composition and wherein the composition is free of protein.

13. The method of claim 9, wherein said limestone is present in an amount of 0.1-99.9% by weight of the dry weight of the total composition,

14. The method of claim 11, wherein said fir bark is present in an amount of 0.1-99.9 % by weight of the dry weight of the total composition,

15. The method of claim 1, wherein administering is performed before seeding of said crop.

16. The method of claim 1, wherein administering is performed simultaneously with seeding of said crop.

17. The method of claim 1, wherein administering is performed after seeding of said crop.

18. A seed composition comprising a crop seed and coating, said coating comprising a polysaccharide, wherein said coating is free of protein.

19. The composition of claim 18, wherein the crop seed is a potato piece.

20. The composition of claim 18, wherein the crop seed is a grain.

21. The composition of claim 20, wherein the grain is barley.

22. The composition of claim 18, wherein the polysaccharide is selected from the group consisting of a cellulosic derivative, starch or a starch derivative, pectin, carrageenan, an exudate gum polysaccharide, polysaccharide derived from seed gum and alginates.

23. The composition of claim 22, wherein the cellulosic derivative is alpha cellulose.

24. The composition of claim 22, wherein the starch or starch derivatives is tapioca starch or corn starch.

25. The composition of claim 22, wherein the exudates gum polysaccharide is gum arabic, gum ghatti, gum karaya, and gum tragacanth.

26. The composition of claim 22, wherein the polysaccharide may be derived from seed gum is guar gum or locust bean gum.

27. The composition of claim 18, wherein said composition further comprises limestone.

28. The composition of claim 18, wherein said composition further comprises a drying agent.

29. The composition 28, wherein the drying agent is fir bark.

30. A method of increasing crop yields, accelerating crop emergence, or accelerating crop maturity, comprising administering to a seed or seed pieces a composition comprising a peptide alone or a polysaccharide alone or a combination of the peptide and polysaccharide in a ratio ranging from 99.9% peptide: 0.1% polysaccharide to 0.1% peptide: 99.9% polysaccharide and an additive, wherein 1-50% of the composition include the peptide and/or the polysaccharide and 50-99% include additives that promote stability and functionality of the composition as a dry powder mix.

31. (canceled)

32. (canceled)

33. The method of claim 30, wherein the seed piece is a potato.

34. The method of claim 30, wherein the seed is a grain.

35. The method of claim 34, wherein the grain is barley.

36. The method of claim 30, wherein administering is performed before seeding of said crop.

37. The method of claim 30, wherein administering is performed simultaneously with seeding of said crop.

38. The method of claim 30, wherein the peptide is isolated from a natural, synthetic or recombinant source.

39. The method of claim 30, wherein the peptide is or is obtained from corn gluten meal, zein, soybean protein, whey protein, Bakers yeast extract, wheat gluten, bone meal, casein, animal collagen, gelatin, wheat flour, edible fish meal, cottonseed meal, corn flour, meat meal, nutria meat, oatmeal, pecan shell flour, pectin, rye flour, edible seaweed, soybean meal, soy flour, soy protein, sugarbeet meal, walnut flour, wheat, whey, ground oats.

40. The method of claim 30, wherein the polysaccharide is selected from the group consisting of a cellulosic derivative, starch or a starch derivative, pectin, carrageenan, an exudate gum polysaccharide, polysaccharide may be derived from seed gum and alginates.

41. The method of claim 40, wherein the cellulosic derivative is alpha cellulose.

42. The method of claim 40, wherein the starch or starch derivatives is tapioca starch or corn starch.

43. The method of claim 40, wherein the exudates gum polysaccharide is gum arabic, gum ghatti, gum karaya, and gum tragacanth.

44. The method of claim 40, wherein the polysaccharide may be derived from seed gum is guar gum or locust bean gum.

45. The method of claim 30, wherein the additive is a solublizing agent, surfactant, emulsifier, pH control agent, buffer, anti-microbial compound, chelating agent, thickener, drying agent, or mixture thereof.

46. The method of claim 45, wherein the solubilizing agent is glycol, propylene glycol, or other low molecular weight alcohols.

47. The method of claim 45, wherein the surfactant is alkylpolyglucosides, fatty alcohols, fatty acids, or alkylbenzenesulfonates and dispersants.

48. The method of claim 45, wherein the emulsifier is lecithin or sorbitan monooleate.

49. The method of claim 45, wherein the pH control agent is mineral acids and their salts, organic acids and their salts, bases, both organic and inorganic.

50. The method of claim 45, wherein the buffer is phosphates, acetates, or carbonates.

51. The method of claim 45, wherein the anti-microbial compound is BHT, methyl or propylparaben, benzoic acid, sorbic acid, or propionic acid and their salts.

52. The method of claim 45, wherein the chelating agent is EDTA, MEA, or TEA.

53. The method of claim 45, wherein the thickener is glucerol.

54. The method of claim 45, wherein the drying agent is fir bark.
